(19) United States
(12) Patent Application Publication
(10) Pub. No.: US 2026/0104832 A1
(43) Pub. Date: Apr. 16, 2026

(54) PRINTING APPARATUS, CONTROL METHOD THEREFOR, AND PRINTING SYSTEM

(71) Applicant: CANON KABUSHIKI KAISHA, Tokyo (JP)

(72) Inventor: Tomoya Miyoshi, Kanagawa (JP)

(21) Appl. No.: 19/394,103

(22) Filed: Nov. 19, 2025

Related U.S. Application Data
(63) Continuation of application No. PCT/JP2024/015153, filed on Apr. 16, 2024.

(30) Foreign Application Priority Data
Jun. 15, 2023 (JP) 2023-098732

(51) Int. Cl. G06F 3/12

(52) U.S. Cl. CPC G06F 3/1238; G06F 3/1222; G06F 3/1232; G06F 3/1267; G06F 3/1288

(57) ABSTRACT

A printing apparatus provides a login function for allowing a user to log into the printing apparatus, configures a setting for enabling the login function, provides, based on the login function being set to be enabled, a printing server with a notification indicating that the printing apparatus is capable of making a cancellation request that requests the printing server to cancel a pending state of a print job held by the printing server, obtains the print job from the printing server after the pending state of the print job is cancelled, and executes printing in accordance with the obtained print job

### CROSS-REFERENCE TO RELATED APPLICATIONS

This application is a Continuation of International Patent Application No. PCT/JP2024/015153, filed Apr. 16, 2024, which claims the benefit of Japanese Patent Application No. 2023-098732, filed Jun. 15, 2023, both of which are hereby incorporated by reference herein in their entirety.

### BACKGROUND

### Field of the Technology

The present disclosure relates to a printing apparatus, a control method therefor, and a printing system.

### Description of the Related Art

In recent years, cloud printing services, in which a print job is input via the cloud and transmitted to a printing apparatus, are becoming widespread (Japanese Patent Laid-Open No. 2012-133489). In some cloud printing services, it is possible to implement a printing method in which a print job is held in a pending state and a printing apparatus is caused to execute printing in response to an additional instruction from a user. Such a printing method can be referred to as hold printing. Some printing apparatuses have a pull printing function that requests cancellation of a pending state of a print job held in a printing server. Some conventional printing apparatuses have a login function and enable the pull printing function only when the login function is enabled. On such printing apparatuses, the hold printing cannot be executed unless the login function is enabled.

### SUMMARY

An aspect of the present disclosure provides a technique to allow hold printing to be executed regardless of whether a login function is enabled. According to some embodiments, a printing system comprising a printing server and a printing apparatus, the printing server comprising: a holding unit configured to hold a print job in a pending state based on a determination that the printing apparatus is capable of making a cancellation request that requests the printing server to cancel the pending state of the print job; a cancellation unit configured to cancel the pending state of the print job based on a request from the printing apparatus or a request from an apparatus different from the printing apparatus; and a transmission unit configured to transmit the print job whose pending state was cancelled to the printing apparatus, and the printing apparatus comprising: a login unit configured to provide a login function for allowing a user to log into the printing apparatus; a setting unit configured to configure a setting for enabling the login function; a notification unit configured to, based on the login function being set to be enabled, provide the printing server with a notification indicating that the printing apparatus is capable of making the cancellation request; an obtainment unit configured to obtain the print job from the printing server after the pending state of the print job is cancelled; and a printing unit configured to execute printing in accordance with the obtained print job is provided.

Features of the present disclosure will become apparent from the following description of embodiments with reference to the attached drawings.

### BRIEF DESCRIPTION OF THE DRAWINGS

FIG. 1 is a block diagram for describing an exemplary configuration of a printing system according to some embodiments;

FIG. 2 is a block diagram for describing an exemplary hardware configuration of a computer according to some embodiments;

FIG. 3A is a block diagram for describing an exemplary hardware configuration of a printing apparatus according to some embodiments;

FIG. 3B is a block diagram for describing an exemplary hardware configuration of a printing apparatus according to some embodiments;

FIG. 4 is a sequence diagram for describing exemplary operations of a badge release according to some embodiments;

FIG. 5 is a diagram for describing exemplary messages used in some embodiments;

FIG. 6 is a diagram for describing an exemplary change in a list of print jobs according to some embodiments;

FIG. 7 is a diagram for describing exemplary messages used in some embodiments;

FIG. 8 is a diagram for describing exemplary messages used in some embodiments;

FIG. 9 is a diagram for describing exemplary messages used in some embodiments;

FIG. 10 is a schematic diagram for describing exemplary screens displayed in some embodiments;

FIG. 11 is a sequence diagram for describing exemplary operations of a mobile release according to some embodiments;

FIG. 12 is a diagram for describing exemplary messages used in some embodiments;

FIG. 13 is a diagram for describing an exemplary change in a list of print jobs according to some embodiments;

FIG. 14 is a diagram for describing exemplary messages used in some embodiments;

FIG. 15 is a diagram for describing exemplary messages used in some embodiments;

FIG. 16 is a flow diagram for describing exemplary operations of a printing apparatus according to some embodiments;

FIG. 17A is a schematic diagram for describing exemplary screens displayed in some embodiments; and

FIG. 17B is a schematic diagram for describing an exemplary screen displayed in some embodiments.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Exemplary Configuration of Printing System

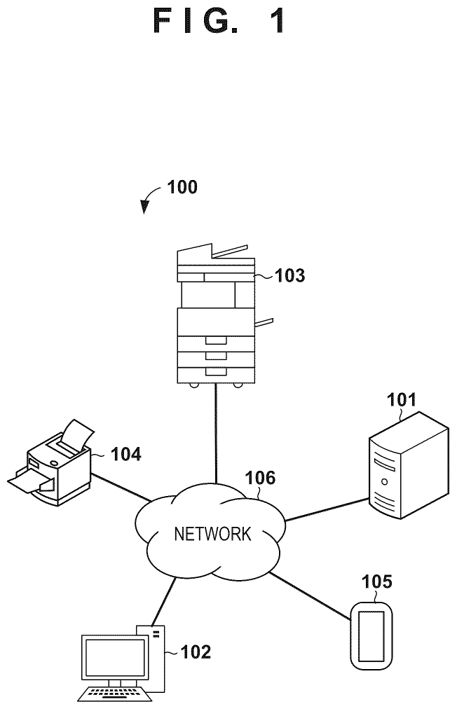

An exemplary configuration of a printing system 100 according to some embodiments will be described with reference to FIG. 1. The printing system 100 includes, for example, a printing server 101, an information processing apparatus 102, a printing apparatus 103, a printing apparatus 104, and a mobile terminal 105. The number of constituent elements in the printing system 100 is not limited to the example of FIG. 1. For example, the printing system 100 may not include one of the printing apparatus 103 and the printing apparatus 104. Also, the printing system 100 may include constituent elements that are not shown in FIG. 1.

Each constituent element in the printing system 100 is connected to a network 106. The printing server 101 may be capable of communicating with each of the information processing apparatus 102, the printing apparatus 103, the printing apparatus 104, and the mobile terminal 105 via the network 106. Communication among the printing server 101 and these other apparatuses may be performed using messages compliant with the Internet Printing Protocol (IPP). The network 106 may be a local area network (LAN), a wide area network (e.g., the Internet), a cellular network, or any combination of these; for example, it may be the Internet. The network 106 may include a wireless section, or may include a wired section.

The printing server 101 provides a printing service that transmits a print job to any printing apparatus (e.g., the printing apparatus 103) in accordance with a print job generated by the information processing apparatus 102. For example, the printing server 101 provides a logical printer to the information processing apparatus 102, and accepts a print job for the logical printer. The logical printer denotes a virtual printing apparatus (e.g., a printer object) provided by the printing server 101. The logical printer can also be referred to as a cloud printer. In contrast to the logical printer, a physical printing apparatus like the printing apparatus 103 can also be referred to as a physical printer.

The printing server 101 may be a server inside an on-premise environment connected to the network 106, or may be a server inside a cloud computing environment (hereinafter simply denoted as a cloud). A printing service provided by the printing server 101 inside the cloud may be referred to as a cloud printing service (hereinafter referred to as a CPS). An example of the cloud printing service is Universal Print® provided by Microsoft Corporation. The following description will be provided in relation to a case where the printing server 101 is present inside the cloud. However, the following description similarly applies also to a case where the printing server 101 is present inside an on-premise environment.

The information processing apparatus 102 provides a printing function to a user of the information processing apparatus 102. The information processing apparatus 102 may be a personal computer (PC), a smartphone, or another device. The information processing apparatus 102 may designate a physical printer connected to the same LAN as an output destination, or may designate a logical printer provided by the printing server 101 as an output destination. In a case where a logical printer has been designated as an output destination, a physical printer (e.g., the printing apparatus 103) associated with the logical printer performs printing (e.g., discharges paper). The information processing apparatus 102 that uses the CPS may be referred to as a client or a client terminal. Printing that is performed by inputting a print job to a logical printer can also be referred to as cloud printing or remote printing.

The printing apparatus 103 includes a printing function of performing printing in accordance with a print job. Printing may be printing on a sheet-shaped recording medium, such as paper, or may be formation of a three-dimensional object (so-called three-dimensional printing). A printing method may be an electrophotographic method, may be an inkjet method, may be a thermal transfer method, or may be another method.

The printing apparatus 103 may further include a login function. The login function may be a function of causing a user to log into the printing apparatus. The printing apparatus 103 with the login function may authenticate the user and provide processing corresponding to the user who has succeeded in the authentication. For example, the printing apparatus 103 may request the user to input a user name and a password.

The printing apparatus 103 supports hold printing. The hold printing may be a printing method in which a print job transmitted from the information processing apparatus 102 to the printing server 101 is held in a pending state in the printing server 101, and the printing apparatus 103 starts printing in response to an additional instruction from the user. The printing apparatus 103 has a pull printing function to support the hold printing. The pull printing function may denote a function of requesting the printing server 101 to cancel the pending state of a print job held in the printing server 101 in response to an instruction from the user. The pull printing function may be referred to as a cancellation request function. In the following description, cancellation of the pending state of a print job performed by the user operating the printing apparatus 103 is denoted as a badge release. The badge release may be referred to as a local release, a direct release, a printer release, and the like. The printing server 101 cancels the pending state of the print job based on a request from the printing apparatus 103. In order to disable printing of a print job input by another user from being started, the printing apparatus 103 may allow the user to execute a badge release on the condition that the user is logged into the printing apparatus 103.

The printing server 101 may cancel the pending state of the print job based on a request from an apparatus (e.g., the mobile terminal 105) different from the printing apparatus 103, in addition to or in place of a badge release. In the following description, cancellation of the pending state that is based on a request from an apparatus different from the printing apparatus 103 is denoted as a mobile release. The mobile release may be referred to as a remote release, an indirect release, and the like.

The printing apparatus 103 may further include at least one of a scanner function and a facsimile function as a major function. A printing apparatus that includes a plurality of major functions in this way may be referred to as a multifunction peripheral (MFP).

The printing apparatus 104 has a printing function, similarly to the printing apparatus 103. On the other hand, unlike the printing apparatus 103, the printing apparatus 104 does not have a login function and a pull printing function. The printing apparatus 104 may be a single function printer (SFP) that only has a printing function as a major function.

The mobile terminal 105 provides a user of the mobile terminal 105 with a function for executing a mobile release. The mobile terminal 105 may be a laptop computer, may be a smartphone, or may be another device. For example, an application that provides a function for executing a mobile release may be installed on the mobile terminal 105. The mobile terminal 105 may have a login function that causes the user to log into the mobile terminal 105. The mobile terminal 105 may allow the user to execute a mobile release on the condition that the user is logged into the mobile terminal 105.

In a typical scenario, the user who has performed hold printing with respect to the printing apparatus 103 with use of the information processing apparatus 102 proceeds to the vicinity of the printing apparatus 103 while carrying his/her mobile terminal 105. Thereafter, the user logs into the mobile terminal 105. The user executes a mobile release with use of the mobile terminal 105, thereby causing the printing apparatus 103 to start printing. Although the mobile release is executed with use of the mobile terminal 105 in this example, the mobile release may be executed with use of an apparatus (e.g., a desktop computer) that is not expected to be mobile-oriented. The mobile terminal 105 may be used to input a print job to the printing server 101.

### Exemplary Hardware Configuration of Computer

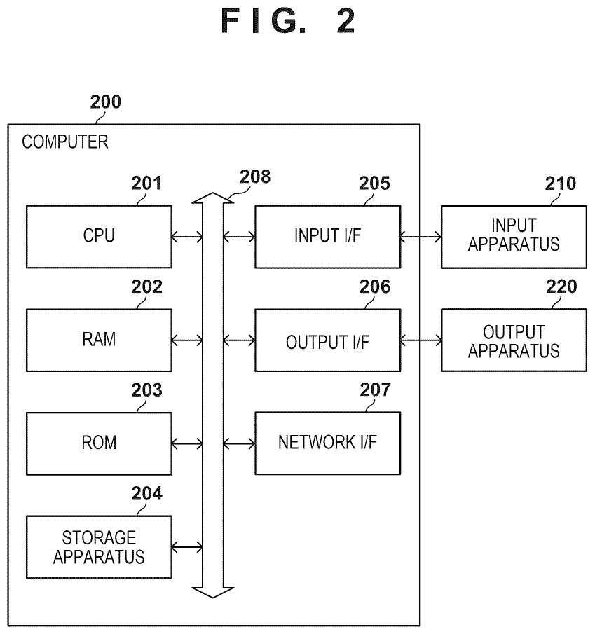

An exemplary hardware configuration of a computer 200 according to some embodiments will be described with reference to FIG. 2. The computer 200 may be used as the printing server 101, may be used as the information processing apparatus 102, or may be used as the mobile terminal 105. The computer 200 may include constituent elements shown in FIG. 2.

A central processing unit (CPU) 201 is a general-purpose processing circuit that controls overall operations of the computer 200. A random-access memory (RAM) 202 is a volatile memory circuit, and is used as a temporary storage area, such as a working area, for processing by the CPU 201. A read-only memory (ROM) 203 is a nonvolatile memory circuit, and stores programs and data that are used in processing of the CPU 201. A storage apparatus 204 is a nonvolatile storage apparatus, and stores programs and data that are used in processing of the CPU 201. The storage apparatus 204 may be, for example, a hard disk drive (HDD) or a solid-state drive (SSD). The storage apparatus 204 can also be referred to as a secondary storage apparatus. Operations by the computer 200 may be realized by the CPU 201 executing a program that has been read out from the storage apparatus 204 to the RAM 202.

An input interface (I/F) 205 is an I/F for exchanging signals with an input apparatus 210. The input apparatus 210 is an apparatus that obtains an input from a user of the computer 200. The input apparatus 210 may be, for example, a keyboard, a touch panel, a microphone, a mouse, or any combination of these. An output I/F 206 is an I/F for exchanging signals with an output apparatus 220. The output apparatus 220 is an apparatus that provides information to the user of the computer 200. The output apparatus 220 may be, for example, a display, a speaker, or any combination of these. A network I/F 207 is an I/F for communicating with an apparatus that is outside the computer 200. Each of the CPU 201, RAM 202, ROM 203, storage apparatus 204, input I/F 205, output I/F 206, and network I/F 207 is connected to a system bus 208. In the example of FIG. 2, the input apparatus 210 and the output apparatus 220 are shown as apparatuses separate from the computer 200. Instead of this, the computer 200 may include the input apparatus 210 and the output apparatus 220.

### Exemplary Hardware Configuration of Printing Apparatus

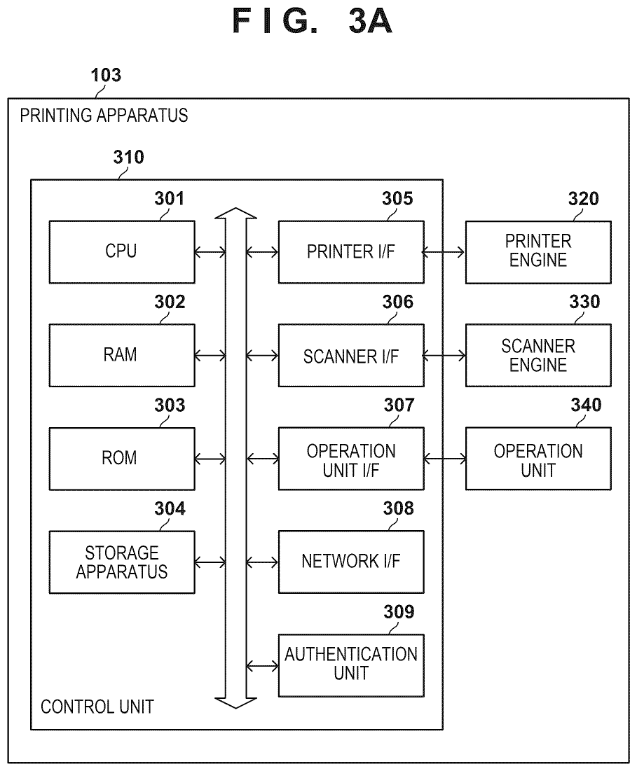

An exemplary hardware configuration of the printing apparatus 103 according to some embodiments will be described with reference to FIG. 3A. The printing apparatus 103 may include constituent elements shown in FIG. 3A. A CPU 301 is a general-purpose processing circuit that controls overall operations of the printing apparatus 103. A RAM 302 is a volatile memory circuit, and is used as a temporary storage area, such as a working area, for processing by the CPU 301. A ROM 303 is a nonvolatile memory circuit, and stores programs and data that are used in processing of the CPU 301. A storage apparatus 304 is a nonvolatile storage apparatus, and stores programs and data (e.g., a print job, image data, and setting information) that are used in processing of the CPU 301. The storage apparatus 304 may be, for example, an HDD or an SSD. The storage apparatus 304 can also be referred to as a secondary storage apparatus. Operations by the printing apparatus 103 may be realized by the CPU 301 executing a program that has been read out from the storage apparatus 304 to the RAM 302.

A printer I/F 305 is an I/F for exchanging signals with a printer engine 320. The printer engine 320 performs printing based on signals (e.g., image signals and a print command) supplied from a control unit 310 via the printer I/F 305. The printing may be printing of an electrophotographic method that transfers and fixes toner onto paper, may be printing of an inkjet method that performs printing by ejecting ink onto paper, or may be three-dimensional printing.

A scanner I/F 306 is an I/F for exchanging signals with a scanner engine 330. The scanner engine 330 supplies signals (e.g., image signals) obtained by reading an original to the control unit 310 via the scanner I/F 306. The CPU 301 may process image signals supplied from the scanner engine 330, and supply recording image signals obtained through this processing to the printer engine 320. Also, the CPU 301 may generate image data based on image signals supplied from the scanner engine 330, and transmit the image data to an external apparatus.

An operation unit I/F 307 is an I/F for exchanging signals with an operation unit 340. The operation unit 340 is an apparatus that obtains an input from a user of the printing apparatus 103, and provides information to the user of the printing apparatus 103. The operation unit 340 may be composed of, for example, a display panel (e.g., a liquid crystal display), a speaker, a touch panel, a keyboard, a button, a touchscreen, or any combination of these.

A network I/F 308 is an I/F for communicating with an apparatus that is outside the printing apparatus 103. The CPU 301, RAM 302, ROM 303, storage apparatus 304, printer I/F 305, scanner I/F 306, operation unit I/F 307, and network I/F 308 compose the control unit 310. Each constituent element included in the control unit 310 is connected to a system bus. An authentication unit 309 authenticates a user who uses the printing apparatus 103. For example, the authentication unit 309 may authenticate the user based on a user name and a password that have been input with use of the operation unit 340. In place of these, or in addition to these, the authentication unit 309 may authenticate the user based on biometric information (e.g., a fingerprint, an iris, a facial shape, and the like) of the user that has been obtained with use of a sensor. In place of this, or in addition to this, the authentication unit 309 may authenticate the user by reading out information from a personal identification card owned by the user.

An exemplary hardware configuration of the printing apparatus 104 according to some embodiments will be described with reference to FIG. 3B. The printing apparatus 104 may include constituent elements shown in FIG. 3B. The printing apparatus 104 may be different from the printing apparatus 103 in that it does not include a scanner I/F 306, an operation unit I/F 307, an authentication unit 309, a scanner engine 330, and an operation unit 340, and may be similar to the printing apparatus 103 in other regards.

### Overall Processing Sequence of Badge Release

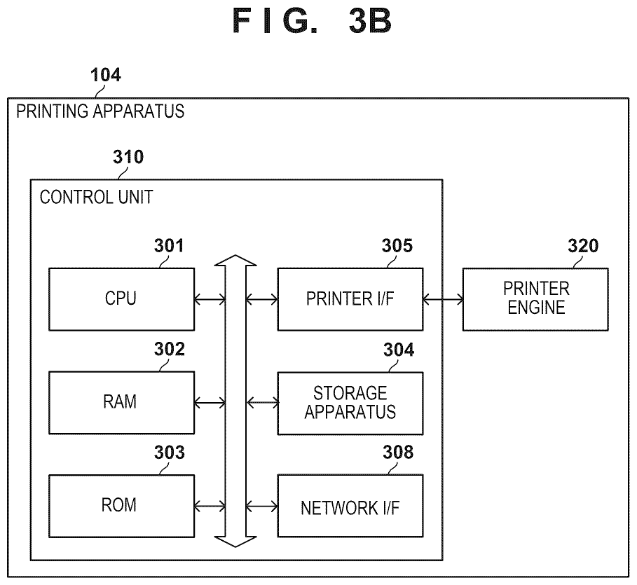

Overall operations of the printing system 100 that are related to processing for executing a badge release will be described with reference to FIG. 4. A badge release may be executable in a case where a printing instruction has been issued to a printing apparatus that has the login function and the pull printing function. As the printing apparatus 103 has the login function and the pull printing function, a user can execute a badge release in a case where he/she has issued a printing instruction to the printing apparatus 103. On the other hand, as the printing apparatus 104 does not have the login function, a user cannot execute a badge release in a case where he/she has issued a printing instruction to the printing apparatus 104. The following describes a case where a printing instruction is issued to the printing apparatus 103.

In step S401, the printing apparatus 103 transmits capability information of the printing apparatus 103 to the printing server 101. The printing server 101 receives this capability information. The capability information may include information indicating the functions that are supported by the printing apparatus 103. It is assumed that, in the operations of FIG. 4, the capability information transmitted in step S401 includes information indicating that the printing apparatus 103 includes the pull printing function. Based on the capability information, the printing server 101 determines that the printing apparatus 103 has the pull printing function.

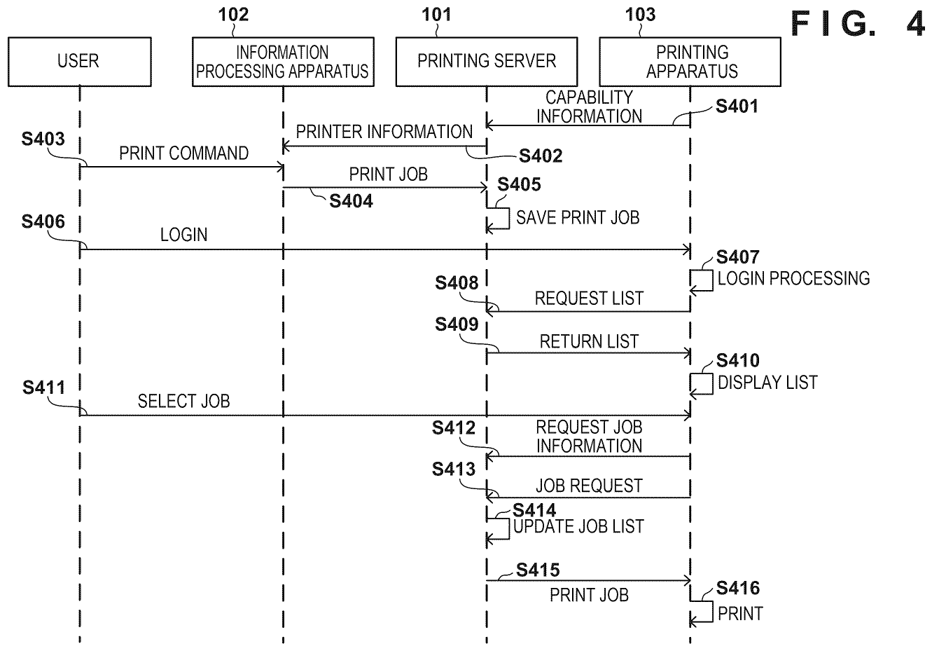

The information indicating that the printing apparatus 103 has the pull printing function may be transmitted with use of a message 500 shown in FIG. 5. The message 500 indicates an Update-Output-Device-Attributes Request operation compliant with the IPP. In the message 500, an attribute “pull-print-supported” is “True”, which indicates that the printing apparatus 103 has the pull printing function. In response to reception of the message 500, the printing server 101 may respond with a message 501 shown in FIG. 5. The message 501 indicates an Update-Output-Device-Attributes Response operation compliant with the IPP.

In step S402, in response to a request from the information processing apparatus 102, the printing server 101 transmits printer information of virtual printers corresponding to one or more printing apparatuses registered with the printing server 101 to the information processing apparatus 102. The information processing apparatus 102 receives this printer information. The one or more printing apparatuses registered with the printing server 101 include the printing apparatus 103.

In step S403, a user of the information processing apparatus 102 (who is assumed to be Smith in the following description) instructs the information processing apparatus 102 to print a print target object (e.g., a document) on a virtual printer provided by the printing server 101. At this point, the virtual printer designated by the user may be associated only with the printing apparatus 103, or may be associated with a plurality of printing apparatuses including the printing apparatus 103. In a case where the virtual printer is associated with a plurality of printing apparatuses, the user may later designate on which printing apparatus printing is to be executed.

In step S404, the information processing apparatus 102 (e.g., a printing application and an operating system thereof) generates a print job in accordance with the instruction from the user, and transmits this print job to the printing server 101. The printing server 101 receives this print job.

In step S405, the printing server 101 assigns an identification number to the print job received in step S404, and saves the print job in a storage (e.g., the storage apparatus 204) of the printing server 101. Also, the printing server 101 updates a job list for managing print jobs held in the printing server 101.

Based on a determination that the printing apparatus 103 has the pull printing function, the printing server 101 processes the print job received in step S404 through hold printing. Specifically, the printing server 101 holds the print job received in step S404 in a pending state. The processing of the print job through the hold printing may be further based on the user's designation of the hold printing. For example, the printing server 101 may not process the print job through the hold printing in a case where the user has not designated the hold printing.

On the other hand, based on a determination that the printing apparatus 103 does not have the pull printing function, the printing server 101 does not process the print job received in step S404 through the hold printing. Specifically, the printing server 101 does not hold the print job received in step S404 in a pending state. In this case, the print job is processed by the printing apparatus 103 (i.e., printing that conforms with the print job is executed) irrespective of an additional instruction from the user.

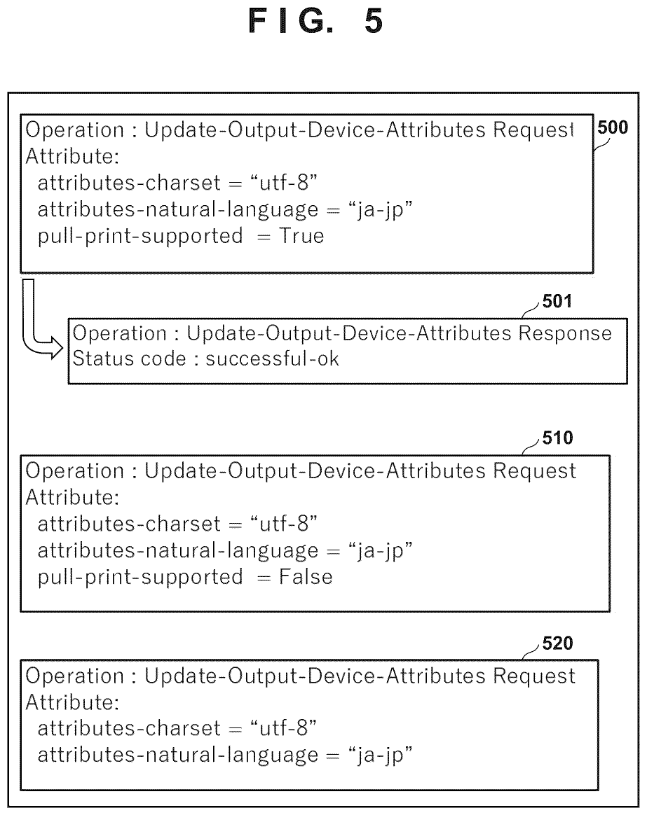

An example of a job list 600 after the update in step S405 will be described with reference to FIG. 6. It is assumed that, in step S405, “3” has been assigned to “job-id” of the print job that has been newly obtained. Accordingly, the printing server 101 sets “job-state” and “job-state-reason” of this print job to “pending-hold” and “job-fetchable-by-user, job-release-wait”, respectively. This indicates that this print job is in a pending state. The job list 600 also manages a print job that was input by the same user (Smith) in the past and is in a pending state (a print job with “job-id” of “2”). The job list 600 also manages a print job that was input by a different user (Alice) in the past and is in a pending state (a print job with “job-id” of “1”). The printing server 101 may manage a print job in association with a cloud account name of a user. For example, a cloud account name of Smith is “RobertSmith@example.com”. The cloud account name may be transmitted from the information processing apparatus 102 to the printing server 101 together with the print job.

In step S406, the user (Smith) logs into the printing apparatus 103 so as to cause the printing apparatus 103 to execute printing that conforms with a print job held by the printing server 101. For example, the user inputs a user name and a password with use of the operation unit 340 of the printing apparatus 103.

In step S407, the printing apparatus 103 executes login processing. Specifically, the printing apparatus 103 authenticates the user by determining whether the information input by the user in step S406 matches information stored therein. In a case where the user authentication has succeeded, the printing apparatus 103 may further determine whether the user is authorized to use the printing apparatus 103. Thereafter, the printing apparatus 103 may specify the cloud account name of the user based on the user name that was input by the user in step S406. Association between the user name and the cloud account name may be set and stored in the storage apparatus 304 of the printing apparatus 103 in advance. For example, the printing apparatus 103 specifies that the cloud account name of the user (Smith) is “RobertSmith@example.com”.

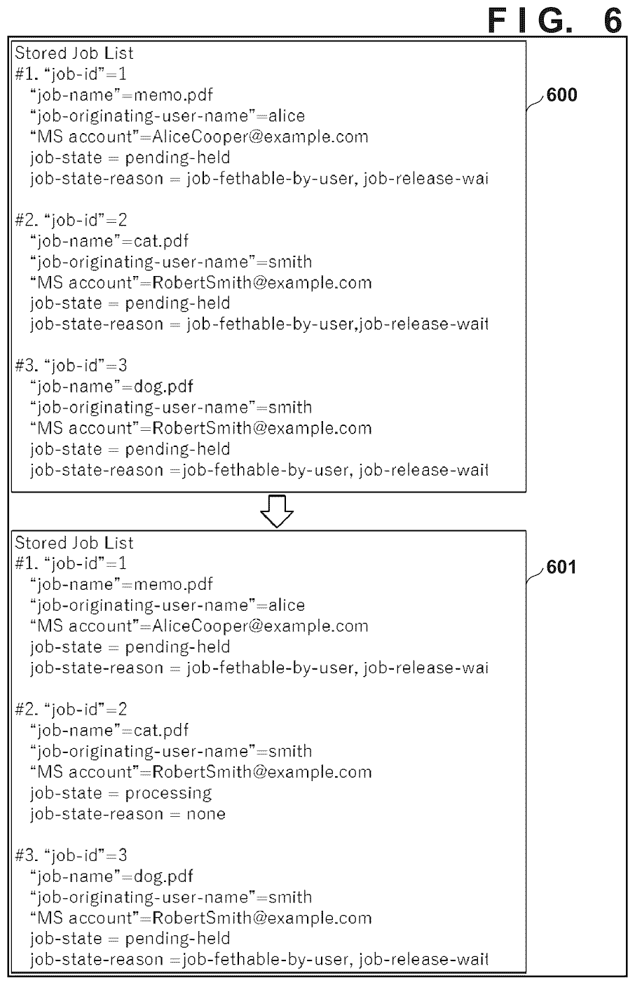

In response to the user's success in the login, the printing apparatus 103 requests the printing server 101 for a list of print jobs associated with the user who is currently logged into the printing apparatus 103 in step S408. The print jobs associated with the user who is currently logged into the printing apparatus 103 include print jobs that have been input by this user and are in a pending state. This request may be transmitted using a message 700 shown in FIG. 7. The message 700 indicates a Get-Jobs Request operation compliant with the IPP. In the message 700, an attribute “my-jobs” is “True”, which indicates that a list of print jobs related to a user designated by an attribute “Requesting-user-name” or an attribute “Requesting-user-uri” is requested. In the message 700, “Smith”, which is a user name, is designated under the attribute “Requesting-user-name”, and “RobertSmith@example.com”, which is a cloud account name of this user, is designated under the attribute “Requesting-user-uri”. In the message 700, both of the attribute “Requesting-user-name” and the attribute “Requesting-user-uri” may be designated, or only one of them may be designated. In place of these, or in addition to these, the message 700 may include other information that is intended for the printing server 101 to uniquely identify the user.

In step S409, the printing server 101 responds to the printing apparatus 103 with a list of print jobs associated with the user designated in step S408. For example, the printing server 101 generates a response list by extracting, from the job list 600, information of a print job associated with “RobertSmith@example.com” designated under the attribute “Requesting-user-uri” (a print job with “job-id” of “2” or “3”). This response list may be transmitted using a message 701 shown in FIG. 7. The message 701 indicates a Get-Jobs Response operation compliant with the IPP. The message 701 includes information of a print job with “job-id” of “2” or “3”.

In step S410, the printing apparatus 103 displays information of the list received in step S409 on the operation unit 340. In step S411, the user designates a print job that he/she wants to print from among one or more print jobs (two print jobs in this example) shown in the list, and issues an instruction to start printing.

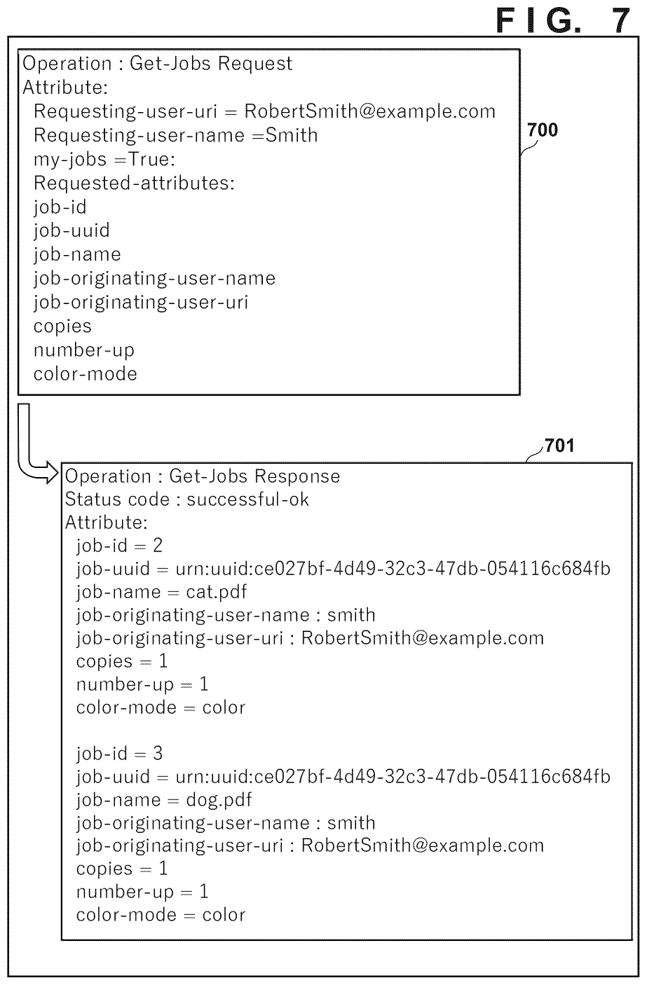

In step S412, the printing apparatus 103 requests the printing server 101 for information of the print job that was designated by the user in step S410 (e.g., the print job with “job-id” of “2”). The printing server 101 receives this request. This request may be transmitted using a message 800 shown in FIG. 8. The message 800 indicates a Fetch-Job Request operation compliant with the IPP. In the message 800, the requested print job is indicated by an attribute “job-id”. An attribute “Requesting-user-uri” in the message 800 indicates the cloud account name of the user who is currently logged into the printing apparatus 103.

In response to the request received in step S412, the printing server 101 responds with information related to the requested print job. The printing apparatus 103 receives this response. This response may be transmitted using a message 801 shown in FIG. 8. The message 801 indicates a Fetch-Job Response operation compliant with the IPP.

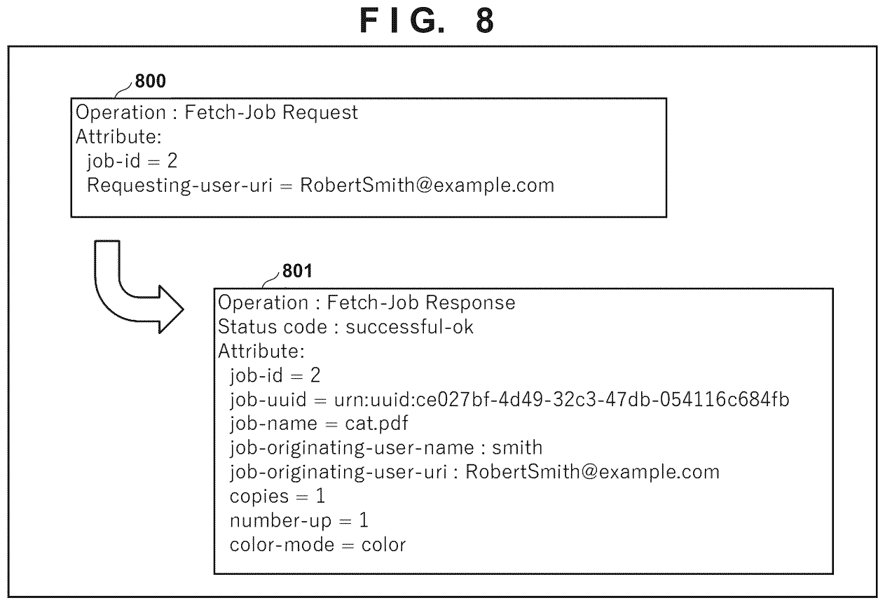

In step S413, the printing apparatus 103 requests the printing server 101 for the print job that was designated by the user in step S410 (e.g., the print job with “job-id” of “2”). The printing server 101 receives this request. This request may be transmitted using a message 900 shown in FIG. 9. The message 900 indicates an Acknowledge-Job Request operation compliant with the IPP. In the message 900, the requested print job is indicated by an attribute “job-id”. An attribute “Requesting-user-uri” in the message 900 indicates the cloud account name of the user who is currently logged into the printing apparatus 103.

In step S414, the printing server 101 cancels a wait state of the print job designated by the printing apparatus 103. Specifically, the printing server 101 updates the job list 600 to a job list 601 as shown in FIG. 6. In the job list 601, “job-state” and “job-state-reason” of the print job with “job-id” of “2” have been updated to “processing” and “none”, respectively. Thereafter, the printing server 101 transmits a confirmation response with respect to the request that was received in step S413. The printing apparatus 103 receives this confirmation response. This confirmation response may be transmitted using a message 901 shown in FIG. 9. The message 901 indicates an Acknowledge-Job Response operation compliant with the IPP.

In step S415, the printing server 101 transmits the print job designated by the printing apparatus 103 to the printing apparatus 103. The printing apparatus 103 receives this print job. In step S416, the printing apparatus 103 executes printing (e.g., executes paper discharge processing) in accordance with the received print job.

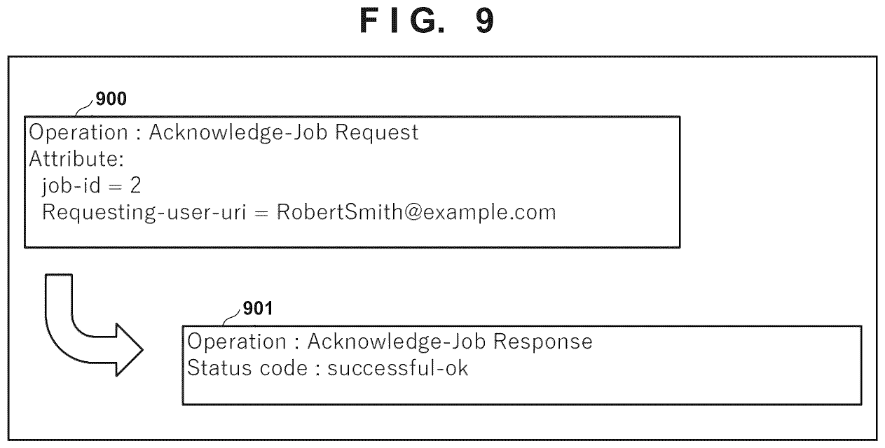

Examples of screens that are displayed on the operation unit 340 of the printing apparatus 103 in a badge release will be described with reference to FIG. 10. In step S407, the printing apparatus 103 displays a screen 1000 on the operation unit 340, thereby suggesting the user to log into the printing apparatus 103. Thereafter, when the user (Smith) has logged into the printing apparatus 103, the printing apparatus 103 displays a screen 1001 on the operation unit 340. The screen 1001 indicates that Smith is currently logged in.

In response to the user's selection of “job list” on the screen 1001, the printing apparatus 103 executes step S408 (a request for a job list). The printing apparatus 103 generates a screen 1002 that includes a list of print jobs that has been obtained in response to this request, and displays the same on the operation unit 340. The screen 1002 includes the list of print jobs associated with the user (Smith) who is currently logged into the printing apparatus 103.

### Overall Processing Sequence of Mobile Release

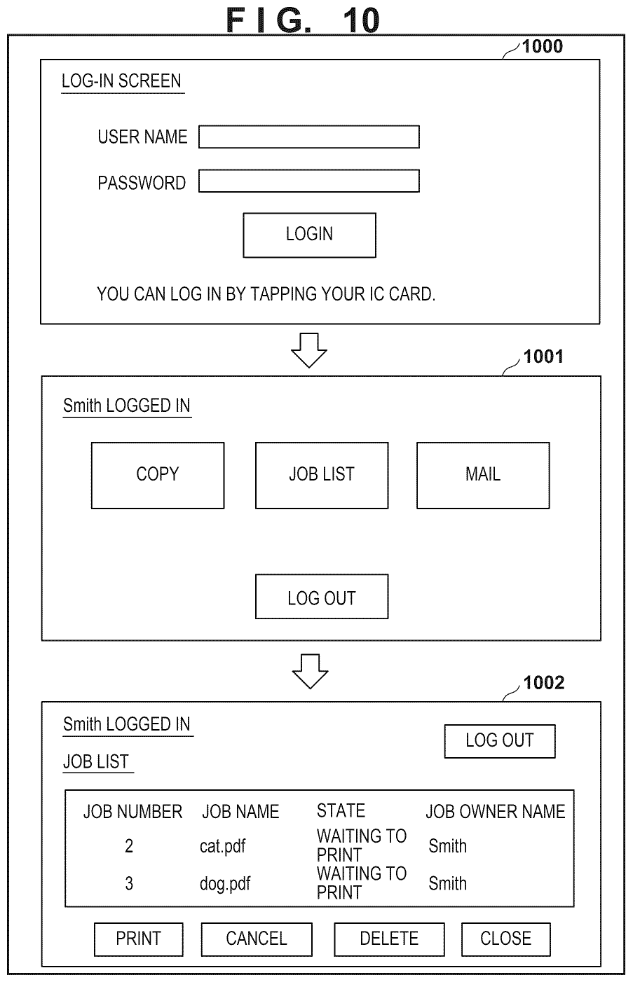

Overall operations of the printing system 100 that are related to processing for executing a mobile release will be described with reference to FIG. 11. A mobile release may be executable in a case where a printing instruction has been issued to a printing apparatus that is recognized by the printing server 101 to have a pull printing function. As the printing apparatus 103 has the pull printing function, a user can execute a mobile release in a case where he/she has issued a printing instruction to the printing apparatus 103. On the other hand, the printing apparatus 104 does not have the pull printing function. However, as will be described later, the printing apparatus 104 provides the printing server 101 with a notification indicating that it has a printing function, even though it does not have the pull printing function. As a result, the printing server 101 recognizes that the printing apparatus 104 has the pull printing function. Therefore, a user can execute a mobile release even in a case where he/she has issued a printing instruction to the printing apparatus 104. The following describes a case where a printing instruction is issued to the printing apparatus 103. A similar description applies also to a case where a printing instruction is issued to the printing apparatus 104.

As the operations of steps S401 to S405 may be similar to FIG. 4, an overlapping description is omitted. In a case where the operations of FIG. 11 are executed by the printing apparatus 104, in step S401, the printing apparatus 104 provides the printing server 101 with a notification indicating that it has the pull printing function, even though it does not have the pull printing function.

In step S1001, a user (Smith) logs into the mobile terminal 105 (e.g., an application that provides a mobile release) so as to cause the printing apparatus 103 to execute printing that conforms with a print job held in the printing server 101. For example, the user inputs a cloud account name (RobertSmith@example.com) and a password with use of the input apparatus 210 of the mobile terminal 105.

In step S1102, the mobile terminal 105 executes login processing. Specifically, the mobile terminal 105 authenticates the user by determining whether the information input by the user in step S1101 matches information stored therein. In a case where the user authentication has succeeded, the mobile terminal 105 may further determine whether the user is authorized to use the printing apparatus 103.

In response to the user's success in the login, the mobile terminal 105 requests the printing server 101 for a list of print jobs associated with the user who is currently logged into the mobile terminal 105 in step S1103. The print jobs associated with the user who is currently logged into the mobile terminal 105 include print jobs that have been input by this user and are in a pending state. This request may be transmitted using a message 700 shown in FIG. 7. As a description related to the message 700 may be similar to the above description, an overlapping description is omitted.

In step S1104, the printing server 101 responds to the mobile terminal 105 with a list of print jobs associated with the user designated in step S1103. As processing of step S1104 may be similar to processing of step S409 described above, an overlapping description is omitted.

In step S1105, the mobile terminal 105 displays information of the list received in step S1104 on the output apparatus 220. This list includes only information of print jobs associated with the user (Smith) who is currently logged into the mobile terminal 105, similarly to the screen 1002 of FIG. 10. In step S1106, the user designates a print job that he/she wants to print from among one or more print jobs (two print jobs in this example) shown in the list, and issues an instruction to start printing.

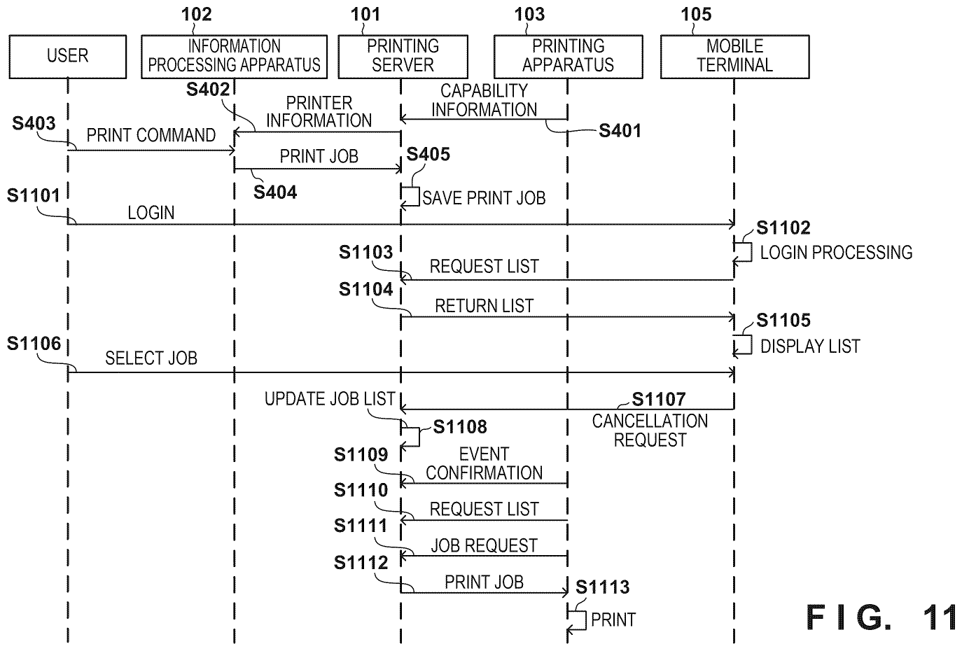

In step S1107, the mobile terminal 105 requests the printing server 101 to cancel the pending state of the print job designated by the user in step S1106 (e.g., the print job with “job-id” of “2”). The printing server 101 receives this request. This request may be transmitted using a message 1200 shown in FIG. 12. The message 1200 indicates a Release-Job Request operation compliant with the IPP. In the message 1200, the print job whose pending state is to be cancelled is indicated by an attribute “job-id”. An attribute “Requesting-user-uri” in the message 1200 indicates the cloud account name of the user who is currently logged into the mobile terminal 105. An attribute “job-release-type” in the message 1200 indicates an identifier of an application that has created the message 1200. The message 1200 including the attribute “job-release-type” indicates that an apparatus different from the printing apparatus (in this example, the mobile terminal 105) has made a request for cancellation of the pending state. A value of the attribute “job-release-type” may be any value that is recognized by the printing system 100.

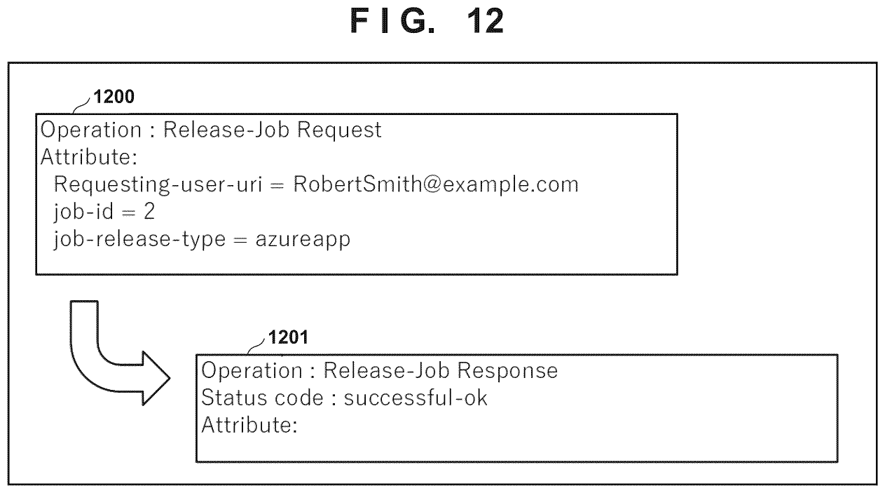

In step S1108, the printing server 101 cancels the wait state of the print job designated by the mobile terminal 105. Specifically, the printing server 101 updates the job list 600 to a job list 1300 as shown in FIG. 13. In the job list 1300, “job-state” and “job-state-reason” of the print job with “job-id” of “2” have been updated to “pending” and “job-fetchable”, respectively. These attribute values indicate that the printing apparatus can obtain the print job with “job-id” of “2”. Thereafter, the printing server 101 transmits a confirmation response with respect to the request that was received in step S1107. The mobile terminal 105 receives this confirmation response. This confirmation response may be transmitted using a message 1201 shown in FIG. 12. The message 1201 indicates a Release-Job Response operation compliant with the IPP.

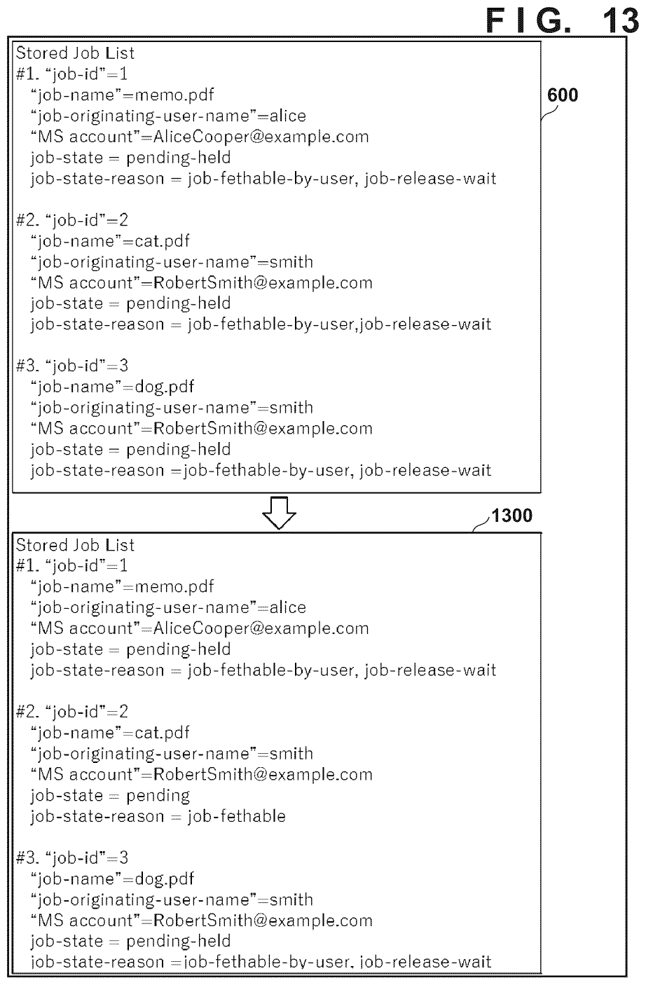

In step S1109, the printing apparatus 103 transmits an event confirmation request to the printing server 101. The printing server 101 receives this event confirmation request. The event confirmation request may be an inquiry about whether an event related to the printing apparatus 103 has occurred. An event related to the printing apparatus 103 may include the presence of a print job that the printing apparatus 103 can obtain. That is to say, the printing apparatus 103 inquires of the printing server 101 about whether there is a print job that the printing apparatus 103 can obtain. The printing apparatus 103 may periodically transmit the event confirmation request to the printing server 101. The event confirmation request may be transmitted using a message 1400 shown in FIG. 14. The message 1400 indicates a Get-Notification Request operation compliant with the IPP.

At this point, the pending state of the print job with “job-id” of “2” has been cancelled based on a request from an apparatus different from the printing apparatus 103 (in this example, the mobile terminal 105). Accordingly, the printing server 101 provides a response indicating that there is a print job that the printing apparatus 103 can obtain. The printing apparatus 103 receives this response. This response may be transmitted using a message 1401 shown in FIG. 14. The message 1401 indicates a Get-Notification Response operation compliant with the IPP.

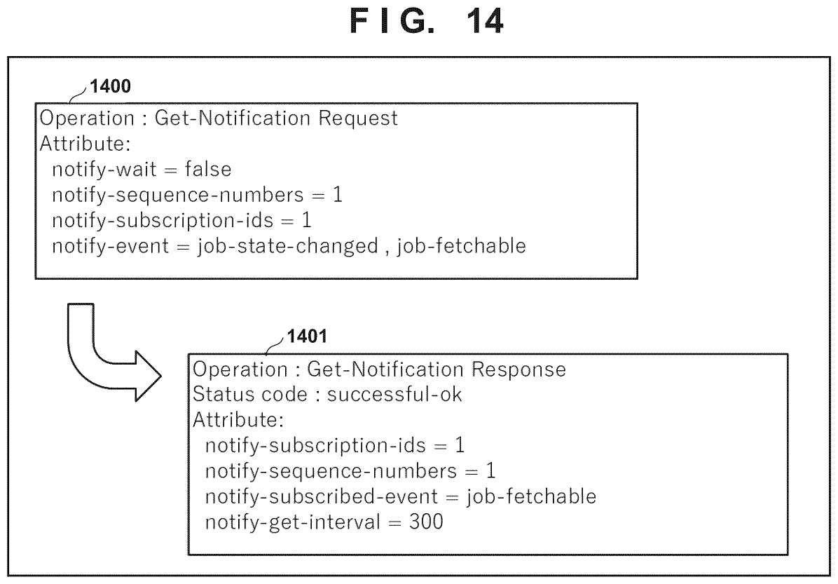

When there are print jobs that the printing apparatus 103 can obtain, the printing apparatus 103 requests the printing server 101 for a list of the print jobs that the printing apparatus 103 can obtain in step S1110. The printing server 101 receives this request. This request may be transmitted using a message 1500 shown in FIG. 15. The message 1500 indicates a Get-Jobs Request operation compliant with the IPP. In the message 1500, an attribute “my-jobs” is “False”, which indicates that information of print jobs related to all users is requested. Furthermore, in the message 1500, an attribute “which-jobs” is “fetchable”, which indicates that information of print jobs that are in a state where they can be obtained by the printing apparatus 103 is requested. The printing server 101 responds with the message 701 in response to the request in step S1110.

In step S1111, the printing apparatus 103 requests the printing server 101 for a print job included in the list obtained in step S1110 (e.g., the print job with “job-id” of “2”). The printing server 101 receives this request. This request may be made by the message 800 of FIG. 8 (i.e., the Fetch-Job Request operation).

In step S1112, the printing server 101 transmits the print job designated by the printing apparatus 103 to the printing apparatus 103. The printing apparatus 103 receives this print job. In step S1113, the printing apparatus 103 executes printing (e.g., executes paper discharge processing) in accordance with the received print job.

### Exemplary Operations of Printing Apparatus

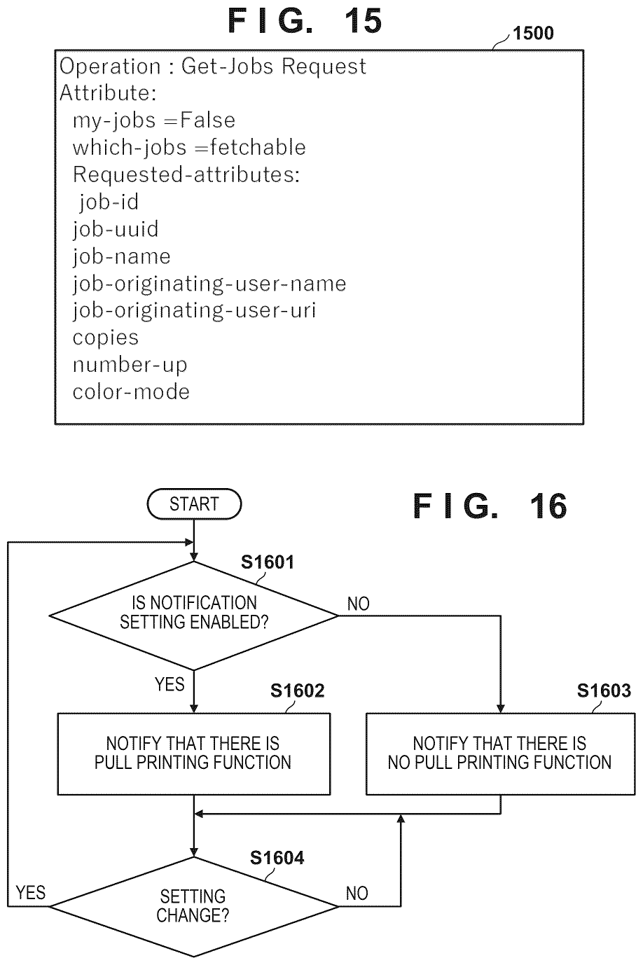

With reference to FIG. 16, a description is given of an example of a control method in which the control unit 310 of the printing apparatus 103 controls the printing apparatus 103 so as to notify the printing server 101 of capability information of the printing apparatus 103. Each step of the method of FIG. 16 may be executed by the CPU 301 of the printing apparatus 103 executing a program that has been read into a memory (e.g., the RAM 302) of the printing apparatus 103. Alternatively, a part or all of the steps of the method of FIG. 16 may be executed by a dedicated integrated circuit, such as an ASIC. The method of FIG. 16 may be started in response to activation of the printing apparatus 103.

In step S1601, the printing apparatus 103 determines whether a setting has been configured to provide the printing server 101 with a notification indicating that the printing apparatus 103 has the pull printing function. In the following description, providing the printing server 101 with a notification indicating that the printing apparatus 103 has the pull printing function will be phrased as a pull printing notification. A state where the printing apparatus 103 is set to provide the pull printing notification will be phrased as the pull printing notification being enabled. A state where the printing apparatus 103 is set so as not to provide the pull printing notification will be phrased as the pull printing notification being disabled. The printing apparatus 103 makes a transition to step S1602 in processing in a case where it has been determined that the pull printing notification is enabled (“YES” of step S1601), and makes a transition to step S1603 in processing otherwise (“NO” of step S1601; for example, in a case where it has been determined that the pull printing notification is disabled).

The setting of the pull printing notification may be stored in a memory (e.g., the RAM 202) of the printing apparatus 103. A default value of the pull printing notification may be enabled or disabled. At the time of activation, the printing apparatus 103 may use a setting value of the pull printing notification that was previously set by a user, or may use the default value.

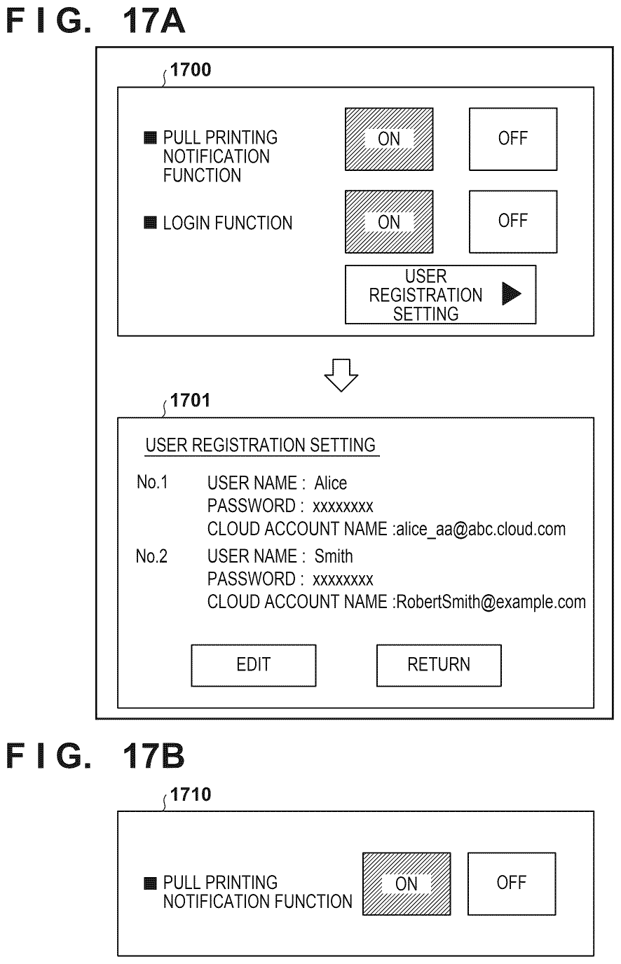

The setting of the pull printing notification may be changeable by a user of the printing apparatus 103. An example of a screen 1700 for configuring the setting of the pull printing notification will be described with reference to FIG. 17A. The screen 1700 may be displayed on, for example, the operation unit 340 of the printing apparatus 103.

The screen 1700 includes an ON button for enabling the pull printing notification, and an OFF button for disabling the pull printing notification. The printing apparatus 103 enables the pull printing notification when the user of the printing apparatus 103 has selected the ON button with use of the operation unit 340. The printing apparatus 103 disables the pull printing notification when the user of the printing apparatus 103 has selected the OFF button with use of the operation unit 340.

The screen 1700 may be further used by the user to set whether to enable the login function of the printing apparatus 103. The screen 1700 includes an ON button for enabling the login function, and an OFF button for disabling the login function. The printing apparatus 103 enables the login function when the user of the printing apparatus 103 has selected the ON button with use of the operation unit 340. The printing apparatus 103 disables the login function when the user of the printing apparatus 103 has selected the OFF button with use of the operation unit 340. In a case where the login function is enabled, the printing apparatus 103 may allow the user to use the printing apparatus 103 only when the user is logged into the printing apparatus 103.

The screen 1700 may be further used to make a transition to a screen 1701 for registering or editing account information of the user. The screen 1700 includes a user registration setting button for making a transition to the screen 1701. The screen 1701 is used to register or edit the account information of the user. The account information may include a user name for logging into the printing apparatus 103, a password for logging into the printing apparatus 103, and a cloud account name, on a user-by-user basis. As described above, a cloud account name may be used in a badge release.

In a case where it has been determined that the pull printing notification is enabled, the printing apparatus 103 provides the printing server 101 with a notification indicating that the printing apparatus 103 has the pull printing function in step S1602. This notification may correspond to step S401 of FIG. 4 or FIG. 11. As described above, the notification indicating that the printing apparatus 103 has the pull printing function may be transmitted with use of a message 500 shown in FIG. 5. The message 500 indicates an Update-Output-Device-Attributes Request operation compliant with the IPP.

In a case where it has been determined that the pull printing notification is disabled, the printing apparatus 103 provides the printing server 101 with a notification indicating that the printing apparatus 103 does not have the pull printing function in step S1603. The notification indicating that the printing apparatus 103 does not have the pull printing function may be transmitted with use of a message 510 shown in FIG. 5. The message 510 indicates an Update-Output-Device-Attributes Request operation compliant with the IPP. In the message 510, an attribute “pull-print-supported” is “False”, which indicates that the printing apparatus 103 does not have the pull printing function. Alternatively, the notification indicating that the printing apparatus 103 does not have the pull printing function may be transmitted with use of a message 520 shown in FIG. 5. The message 520 indicates an Update-Output-Device-Attributes Request operation compliant with the IPP. The message 520 that does not include the attribute “pull-print-supported” indicates that the printing apparatus 103 does not have the pull printing function.

In step S1604, the printing apparatus 103 determines whether the setting of the pull printing notification has been changed. The printing apparatus 103 makes a transition to step S1601 in processing in a case where it has been determined that the setting of the pull printing notification has been changed (“YES” of step S1604), and repeats step S1604 otherwise (“NO” of step S1604). In a case where it has been determined that the setting of the pull printing notification has been changed, the printing apparatus 103 notifies the printing server 101 of whether the printing apparatus 103 has the pull printing function based on the setting after the change.

In the operations of FIG. 16, it is possible to set whether to enable the pull printing notification, and whether to enable the login function, on an individual basis. Therefore, when a setting for providing the printing server 101 with a notification indicating that the printing apparatus 103 has the pull printing function has been configured, the printing apparatus 103 provides the printing server 101 with a notification indicating that the printing apparatus 103 has the pull printing function, regardless of a setting about whether to enable the login function. On the other hand, when a setting for not providing the printing server 101 with a notification indicating that the printing apparatus 103 has the pull printing function has been configured, the printing apparatus 103 does not provide the printing server 101 with a notification indicating that the printing apparatus 103 has the pull printing function, regardless of a setting about whether to enable the login function. In a case where the pull printing notification is enabled and the login function is enabled, the user can execute both of a badge release and a mobile release. In a case where the pull printing notification is enabled and the login function is disabled, the user can execute neither a badge release nor a mobile release. In a case where the pull printing notification is disabled and the login function is enabled, the user cannot execute a badge release, but can execute a mobile release. In a case where the pull printing notification is disabled and the login function is disabled, the user can execute neither a badge release nor a mobile release.

The control method of FIG. 16 may be executed by the printing apparatus 104. In this case, each step of the method of FIG. 16 may be executed by the CPU 301 of the printing apparatus 104 executing a program that has been read into a memory (e.g., the RAM 302) of the printing apparatus 104. Alternatively, a part or all of the steps of the method of FIG. 16 may be executed by a dedicated integrated circuit, such as an ASIC. The method of FIG. 16 may be started in response to activation of the printing apparatus 103.

As described above, the printing apparatus 104 does not have the pull printing function. Therefore, in the method of FIG. 4 related to a badge release, the printing apparatus 104 cannot request the printing server 101 to cancel the pending state of a print job in step S412. However, the printing apparatus 104 can provide the printing server 101 with a notification indicating that it has a printing function, even though it does not have the pull printing function. As a result, the printing server 101 recognizes that the printing apparatus 104 has the pull printing function. Therefore, a user can execute a mobile release even in a case where he/she has issued a printing instruction to the printing apparatus 104.

The setting of the pull printing notification on the printing apparatus 104 may be changeable by a user. An example of a screen 1710 for configuring the setting of the pull printing notification will be described with reference to FIG. 17B. The screen 1710 may be displayed on, for example, a display unit of an apparatus different from the printing apparatus 104 (e.g., the information processing apparatus 102 or the mobile terminal 105). The printing apparatus 104 may be capable of providing a remote user interface (RUI) to display the screen 1710 on a different apparatus. Alternatively, the printing apparatus 104 may include a display unit for displaying the screen 1710.

As a method of setting the pull printing notification on the screen 1710 may be similar to that on the screen 1700, an overlapping description is omitted. As the printing apparatus 104 does not have the login function, the screen 1710 does not include a graphical object for enabling the login function.

In the aforementioned example, the printing apparatus 104 does not have the pull printing function due to the absence of the login function therein. The printing apparatus 104 may not have the login function due to the absence of a user authentication function therein, or may not have the login function due to the absence of an operation unit for inputting a user name and a password therein.

The above-described embodiment makes it possible to execute hold printing, regardless of whether the login function is enabled.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A printing system comprising a printing server and a printing apparatus,
the printing server comprising:
a holding unit configured to hold a print job in a pending state based on a determination that the printing apparatus is capable of making a cancellation request that requests the printing server to cancel the pending state of the print job;
a cancellation unit configured to cancel the pending state of the print job based on a request from the printing apparatus or a request from an apparatus different from the printing apparatus; and
a transmission unit configured to transmit the print job whose pending state was cancelled to the printing apparatus, and
the printing apparatus comprising:
a login unit configured to provide a login function for allowing a user to log into the printing apparatus;
a setting unit configured to configure a setting for enabling the login function;
a notification unit configured to, based on the login function being set to be enabled, provide the printing server with a notification indicating that the printing apparatus is capable of making the cancellation request;
an obtainment unit configured to obtain the print job from the printing server after the pending state of the print job is cancelled; and
a printing unit configured to execute printing in accordance with the obtained print job.

2. The printing system according to claim 1, wherein
based on a setting for not providing the printing server with the notification indicating that the printing apparatus is capable of making the cancellation request being configured, the notification unit does not provide the printing server with the notification indicating that the printing apparatus is capable of making the cancellation request, regardless of a setting of whether to enable the login function.

3. The printing system according to claim 1, wherein
the obtainment unit further obtains, from the printing server, information of a print job associated with a user currently logged into the printing apparatus.

4. The printing system according to claim 1, wherein
based on a determination that the printing apparatus is not capable of making the cancellation request, the holding unit does not hold the print job in the pending state.

5. The printing system according to claim 1, wherein
the printing apparatus further comprises an inquiry unit configured to inquire of the printing server about whether there is a print job that the printing apparatus can obtain, and
the printing server further comprises a response unit configured to, in a case where the pending state of the print job is cancelled based on the request from the apparatus different from the printing apparatus, make a response indicating that there is a print job that the printing apparatus can obtain, in response to the inquiry from the inquiry unit.

6. The printing system according to claim 1, wherein
the apparatus that transmits the request to cancel the pending state of the print job has a login function for allowing a user to log into the apparatus.

7. The printing system according to claim 1, wherein
the notification unit provides the printing server with the notification indicating that the printing apparatus is capable of making the cancellation request with use of a message compliant with Internet Printing Protocol.

8. The printing system according to claim 1, wherein
the setting unit configures a setting for providing the printing server with the notification indicating that the printing apparatus is capable of making the cancellation request, and
the notification unit provides the printing server with the notification indicating that the printing apparatus is capable of making the cancellation request further based on a setting for providing the printing server with the notification indicating that the printing apparatus is capable of making the cancellation request being configured.

9. A printing apparatus, comprising:
a login unit configured to provide a login function for allowing a user to log into the printing apparatus;
a setting unit configured to configure a setting for enabling the login function;
a notification unit configured to, based on the login function being set to be enabled, provide a printing server with a notification indicating that the printing apparatus is capable of making a cancellation request that requests the printing server to cancel a pending state of a print job held by the printing server;
an obtainment unit configured to obtain the print job from the printing server after the pending state of the print job is cancelled; and
a printing unit configured to execute printing in accordance with the obtained print job.

10. A non-transitory computer readable storage medium storing a program for causing a computer to function as the printing apparatus according to claim 9.

11. A method for controlling a printing apparatus, the method comprising:
providing a login function for allowing a user to log into the printing apparatus;
configuring a setting for enabling the login function;
providing, based on the login function being set to be enabled, a printing server with a notification indicating that the printing apparatus is capable of making a cancellation request that requests the printing server to cancel a pending state of a print job held by the printing server;
obtaining the print job from the printing server after the pending state of the print job is cancelled; and
executing printing in accordance with the obtained print job.
